(19) United States
(12) Patent Application Publication
(10) Pub. No.: US 2010/0238409 A1
(43) Pub. Date: Sep. 23, 2010

(54) APPARATUS FOR PROJECTING IMAGES IN SEQUENCE

(75) Inventors: Fabio Allegri, Castel Goffredo (IT); Mauro Favalli, Castel Goffredo (IT)

Correspondence Address: Pearne & Gordon LLP, 1801 East 9th Street, Suite 1200, Cleveland, OH, 44114-3108, US

(73) Assignee: COEMAR S.P.A., I-46042 Castel Goffredo (IT)

(21) Appl. No.: 12/682,960

(22) PCT Filed: Jan. 30, 2008
(86) PCT No.: PCT/IB2008/050327

§ 371 Date: Apr. 14, 2010

(30) Foreign Application Priority Data
Oct. 16, 2007 (IT) PR2007A000077

(51) Int. Cl. G03B 21/44

(52) U.S. Cl. 352/173; 352/183

(57) ABSTRACT

An apparatus (1) for projecting images in sequence comprises a light source arranged in such a way as to direct a light beam in a direction of projection, a plurality of filters (4) with impressed shapes, able to project images corresponding to said shapes when traversed by the light beam, a conveyor element (5) defining a closed line, movable in continuous cycle, the filters (4) being associated to the conveyor element in such a way as to intercept the light beam to generate an animated effect in the projection; the conveyor (5) defines a line having at least one rectilinear segment arranged in such a way that the filters (4) intercept the light beam moving along a straight line perpendicular to the light beam. The projections can be of planar geometric shapes applicable to any lighting apparatus. In projection apparatuses currently in use, the animated effects obtained by moving filters have poor effectiveness, because the filters are constrained to move with circular trajectory.

### TECHNICAL FIELD AND BACKGROUND ART

The present invention relates to an apparatus for projecting images in sequence.

In particular said projectors comprise a light source, positioned such as to direct a beam of light in a direction of projection, and means for placing one or more images impressed on corresponding filters downstream of the light source to project the image.

The invention relates to the sector of lighting engineering and in particular of projectors dedicated to entertainment.

The lighting engineering market dedicated to entertainment offers equipment that is able to project coloured, shaped, zoomable light beams; in most cases, the projection of silhouettes is reserved to the gobos (which in many cases are rotating) mounted on a motorised wheel. Instead, the apparatuses projecting moving images are the so-called videoprojectors, able to project videos by means of an LCD matrix (controlled by a computer or an apparatus for the reproduction of tapes or DVDs) traversed by a light beam, or the actual cinematographic projectors, which project through a beam of light the images present on a celluloid reel that has previously been impressed and developed. These apparatuses have the drawback of not allowing to project images on amble surfaces and over long distances with the possibility to obtain static images.

There are also lighting engineering apparatuses designed to reproduce images and animations against architectural elements, projecting a beam of light through a film, however such apparatuses do not produce images that can be integrated with other special effects (colour, strobe, silhouettes, prisms, etcetera) and being very bulky and heavy they can project images only in one direction; moreover, in the case of the aforementioned film projectors, once the sequence is projected it is necessary to rewind the reel.

Other technical solutions pertaining to projectors for entertainment provide for positioning individual photograms/filters on a conveyor element constituted by a wheel which, turning at variable speed, allows the light beam to project a moving image. However, this solution too has some limitations, because it does not allow to obtain sliding images of captions or particular graphic motifs because to the small number of photograms that can be installed and of the empty gaps between a photogram and the other; moreover, it does not allow integration with other optical effects.

Therefore, these solutions do not allow to project images in sequence with the possibility to add superposed animated effects.

Moreover, it should be considered that, in this solution, each filter along its path slides downstream of the light source along an arc of circumference, when it intercepts the light beam to generate the animated effect on the projected image.

Therefore, this solution is disadvantageous because it does not allow to generate a continuous, consistent effect, with forms or letters sliding on the projected image in a desired direction, for the filters necessarily move along a trajectory defining an arc of circumference.

It should also be observed that, traditionally, the figures to be projected, known as “gobos”, positioned on a wheel, can be projected only one at a time and rotated on their axis.

### DISCLOSURE OF THE INVENTION

An object of the present invention is to eliminate the aforesaid drawbacks and to make available an apparatus for projecting images in sequence, with the possibility to generate an animated effect exploiting a sequence of static images.

Another object of the present invention is to make available a projecting apparatus with the possibility to integrate said animated effects with other optical effects.

Said objects are fully achieved by the apparatus of the present invention, which is characterised by the contents of the appended claims and in particular in that the closed line defined by the conveyor element has at least one rectilinear portion positioned perpendicularly to the light beam, in such a way that the filters intercept the light beam perpendicularly thereto, in their movement along said rectilinear portion of the conveyor element.

### BRIEF DESCRIPTION OF DRAWINGS

This and other characteristics shall become more readily apparent from the following description of a preferred embodiment, illustrated purely by way of non limiting example in the accompanying drawing tables, in which:

FIG. 1 shows an apparatus according to the present invention;

FIG. 2 shows partially see-through view of the conveyor element of the apparatus of FIG. 1;

FIG. 3 shows the apparatus of FIG. 1, according to an embodiment variant;

FIG. 4 shows the apparatus of FIG. 3, with the conveyor element in deactivated position;

FIG. 5 shows the apparatus of FIG. 3, with the conveyor element in a different operative position;

FIG. 6 shows the apparatus of FIG. 5, with the conveyor element in deactivated position;

FIG. 7 shows the apparatus of FIG. 3, with the conveyor element in an operative position between those of FIGS. 3 and 5;

FIG. 8 shows the apparatus of FIG. 7, with the conveyor element in deactivated position.

### BEST MODE FOR CARRYING OUT THE INVENTION

In the figures, the reference number 1 designates an apparatus according to the present invention.

The apparatus 1 is an apparatus for projecting images in sequence (e.g., slides), in particular for applications in which the images are projected onto surfaces of various dimensions.

The apparatus 1 comprises a light source 11 positioned such as to direct a beam of light in a direction of projection.

With regard to the light source 11, halogen or discharge lamps of different power can be used, positioned on the horizontal or the vertical axis relative to the assembly. Moreover, LED light sources can also be used.

The function of the light source is to generate a beam of light in a direction of projection.

For this purpose, a light conveyor 12 is provided, also known as a parabola. Various parabola solutions can be used for different shapes, dimensions and treatments. As an alternative to the parabola, an optical condenser can be used. If LED technology is used for the light source, appropriate lenses can be used, to be applied to give different angles and effects to the projection.

Moreover, it should be noted that a system of lenses 13 is used to control the amplitude of the light beam, i.e. of the projection.

The projector (i.e. the projection apparatus 1) comprises a frame 2 in the shape of a plate defining a hole 3 through which the beam of light produced by the light source is conveyed.

The projector is provided with filters 4 with impressed shapes of different silhouettes, able to project images corresponding to said shapes when they are impacted by the light beam. Said filters are preferably constituted by glasses treated by means of appropriate methods (which are substantially known).

In practice, the filters 4 constitute templates defining drawings or alphanumeric characters or any shapes. In particular, through particular processes supports able to withstand high temperatures are obtained, in order to obtain images that are wholly similar to common slides, but resistant to the heat developed by high-power projection lamps.

The filters 4 are associated to a conveyor element 5 associated to the frame 2.

The conveyor element 5 comprises, in the illustrated example, a chain 6 mounted on a crown gear 7 and a system of transmissions 8.

The conveyor element 5 defines a closed line and it is actuated by means of the pulley 7 (connected to a known motorization, not shown) in continuous cycle.

The conveyor element 5 is so arranged that each filter 4, along its path, slides downstream of the light source and preferably downstream of the hole 3, intercepting the light beam to generate the animated effect on the projected image.

It should be observed that the conveyor element 5 is movable in both the directions of rotation, with the possibility to reverse the direction of rotation.

The filters 4 are engaged to the links of the chain 6. The chain is actuated is by the crown gear 7, in turn actuated by a motor that is coaxial thereto.

Alternatively to the chain 6, for example, a belt set down on a pulley is used.

Said belt can have planar, trapezoidal section, with or without teeth; said belt is provided with a plurality of supports on its outer surface, whereto are associated the corresponding filters 4. Said supports are associated to the belt by means of removable fastening devices. Each support has a seat to enable to fasten a filter in a non definitive manner and allow to replace or compose at will the entire sequence to be projected.

In any case, the conveyor element 5, originally, defines a closed line having at least one rectilinear portion or segment arranged in such a way that the filters 4 intercept the light beam moving along a straight line perpendicular to the light beam. In this way, the projected shapes move in a straight line, to generate said animation.

Hence, said rectilinear portion of the conveyor element 5 is positioned perpendicularly to the light beam.

This advantageously enables to make captions slide and to generate particularly interesting effects, without those watching the projections having an impression of artificiality of the effect.

The apparatus 1 preferably also comprises a shutter, means for varying the colour of the light beam, section interacting with the light beam to generate prismatic effects on the projected images and means for shaping said light beam (not shown because they are known in themselves), operatively active on the light beam in combination with the filters 4.

The apparatus is also provided with a section (not shown because it is known in itself) that interacts with the light beam to generate prismatic effects on the projected images.

In this way, it is possible to obtain a great variety of combined effects.

The projector also comprises a projection element 9 defining a guide for the sliding of the ends of the filters 4.

It should be noted that the conveyor element 5, together with the filters 4 associated thereto, constitutes an animation assembly 10.

The conveyor element 5, or the animation assembly 10, is positioned in a plane substantially perpendicular to the direction of projection, i.e. it is positioned in a vertical plane, parallel to the frame 2.

Moreover, the conveyor element 5, i.e. the animation assembly 10, originally, can be oriented from 0 to 180 degrees to incline the animated image.

The apparatus comprises means for actuating the conveyor element 5, or the animation assembly 10, in a plane perpendicular to the axis projection between at least a first and a second operative position, such that the rectilinear segment of the conveyor element is inclined by a predetermined angle, in the passage from the first to the second position and vice versa.

In this way, the rectilinear segment of the conveyor element can be inclined with continuity by an angle of at least 180 degrees.

This enables, advantageously, to obtain multiple variants of the animated effect, with possibility also to modify it dynamically during the projection.

Moreover, the conveyor element 5, or the animation assembly 10, is movable between an operative position, in which at least one of the filters 4 intercepts the light beam, and a deactivated position, in which the filters 4 are in a position of non interference with the light beam.

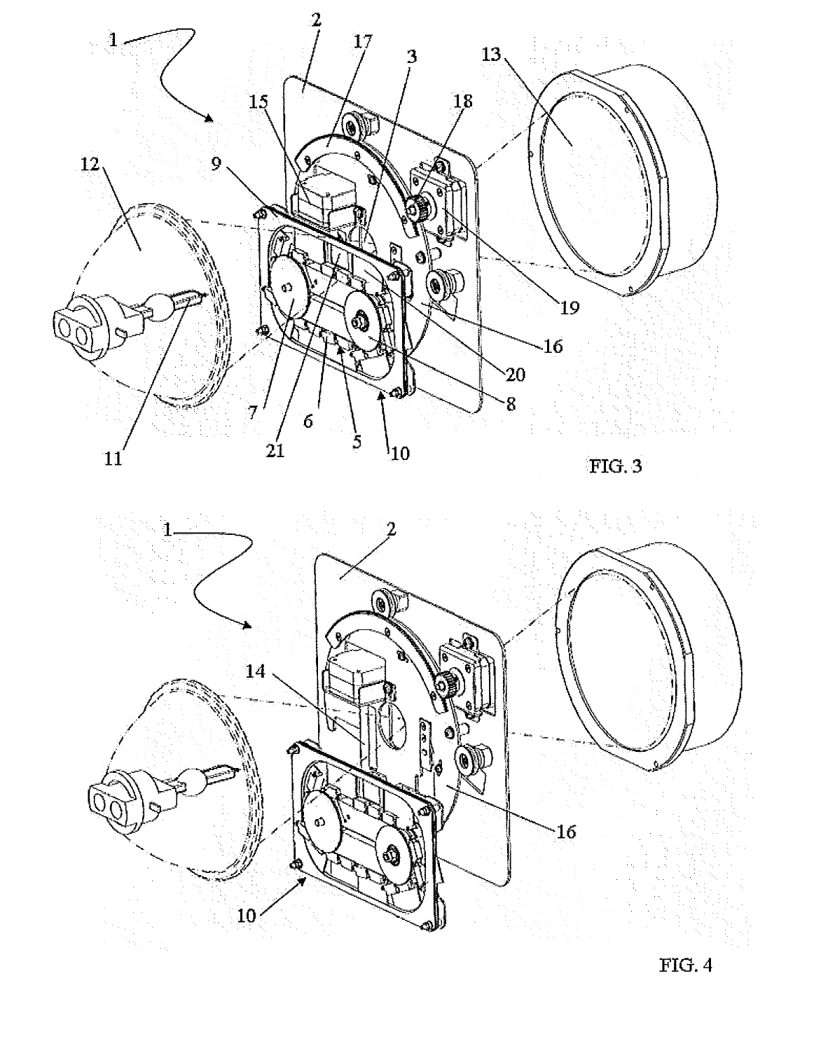

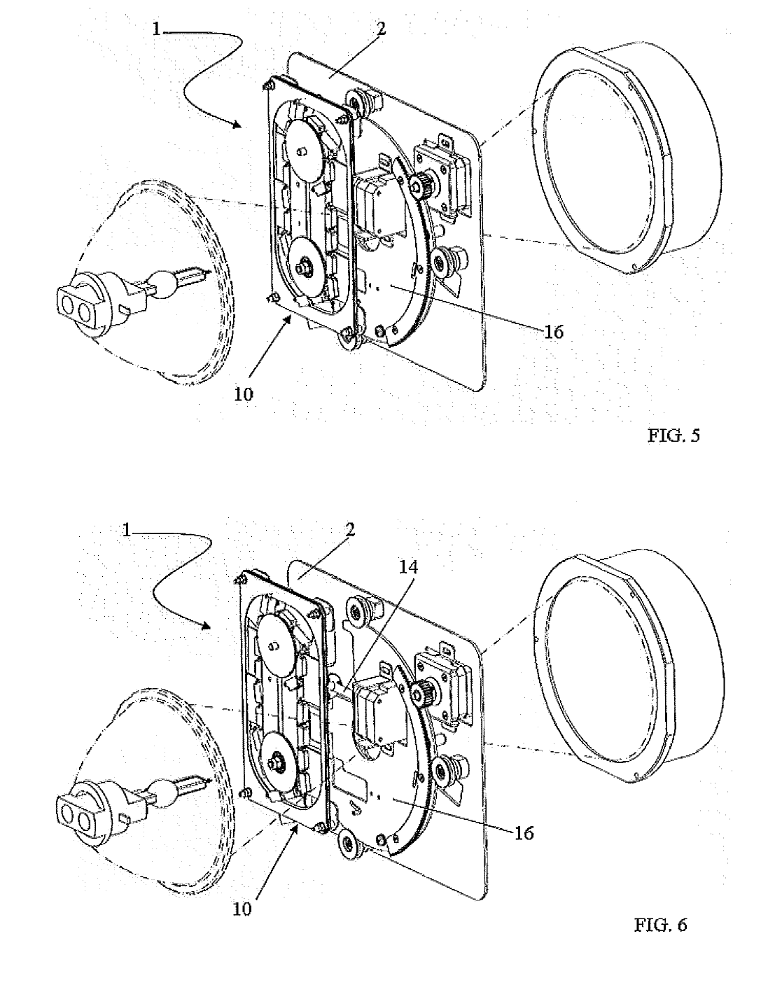

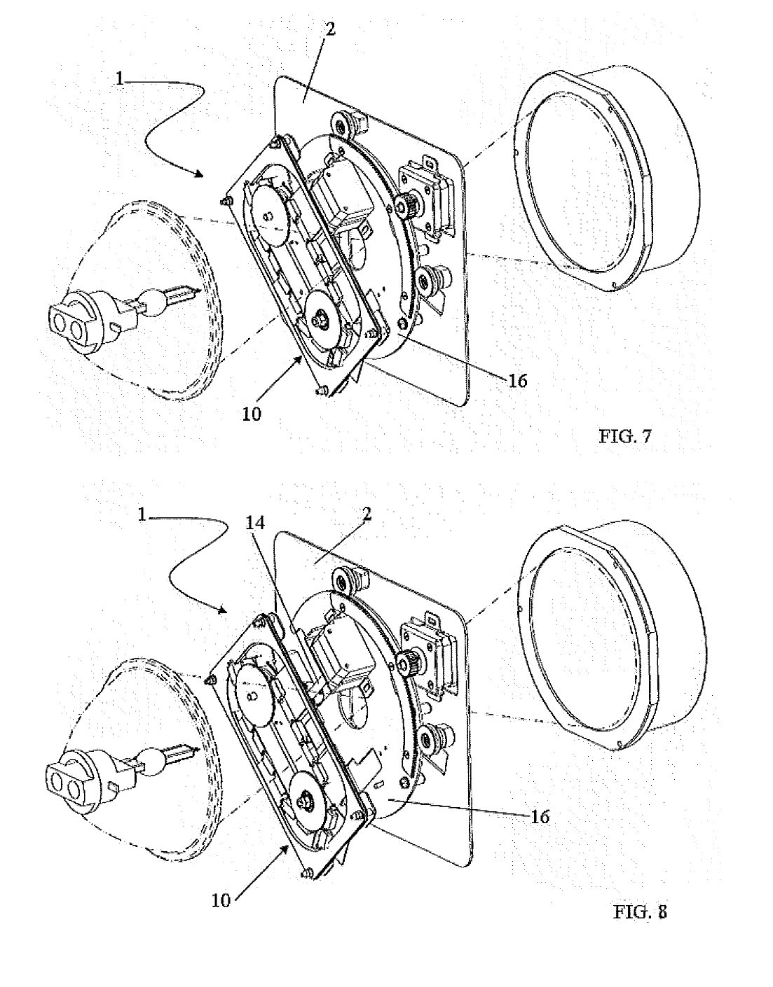

Note that the animation assembly 10 is movable from the operative position (in which the animated effect is generated) to the deactivated position in any operative position in which it may be, i.e. regardless of the angle of inclination of the rectilinear segment of the conveyor element 5. For example, in FIGS. 3, 5 and 7 the animation assembly 10 is in operative position (with activated animation effect) in horizontal, vertical and oblique position, respectively. In FIGS. 4, 6 and 8 the animation assembly 10 is in deactivated position, in the horizontal, vertical and oblique positions, respectively.

Therefore, the animation assembly 10 can always be moved in order temporarily to eliminate the animation. In particular, the animation assembly 10 is translated by means of a worm screw 14 actuated by a motor 15 associated to a support flange 16 pivotally associated to the frame 2. Said support flange 16 can rotate around the axis of the light beam such as to incline the projection at will; the rotation of the support flange 16 is possible thanks to a toothed sector 17 positioned on the edge of the support flange 16 and interacting with a pinion 18 actuated by an to additional motor 19 associated to the frame 2.

Therefore, the animation assembly 10 is slidably associated to the support flange 16, relative to which it translates, actuated by actuation means constituted by the worm screw 14 and by the engine 15.

The flange 16 is pivotally associated to the frame 2 and it is set in rotation by additional actuation means constituted by the circular sector 17, by the pinion 18 and by the additional motor 19.

Therefore, the composition of the movements of translation and rotation of the animation assembly 10, combined originally with the presence of a rectilinear segment in the closed line defined by the conveyor element 5, enables to make a sequence of filters 4 slide through the light beam (projecting corresponding moving images) with any inclination and in a straight line, thereby generating an animated effect, with also the possibility of activating and deactivating said effect at any time.

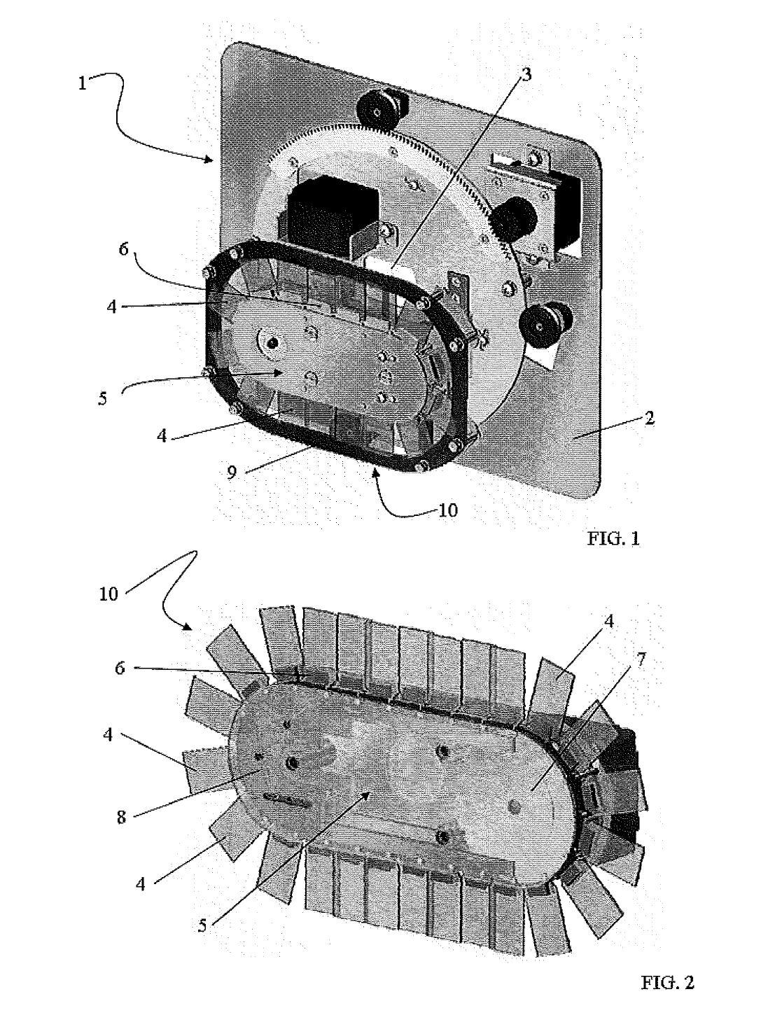

Not also that the present invention provides a first embodiment (FIGS. 1 and 2) and a second embodiment (FIGS. 3-8).

According to the first embodiment, the hole 3 defined by the frame 2, originally, has substantially rectangular shape, or otherwise a predefined shape (rectangular, square, triangular or any other shape); this enables to define the projection surface and area according to the desired shape, with the possibility to focus the images.

Instead, in the second embodiment the animation assembly 10 is provided with an opaque surface 20 originally defining a rectangular hole 21 (or a hole of the desired shape, as described above), whilst the hole 3 defined by the frame 2 has greater dimensions than the hole 21 (and it has, for example, circular shape).

The portion of light that defines the projection passes through the opening indicated by the reference number 21 in FIG. 3. Said passage can have different shapes (for example, square, rectangular, circular, triangular) and it delimits the area of projection and the focusing of the images.

Downstream of the opening 21 is present a hole 3 on the support 2 of greater size than the opening 21 to allow the passage of light.

Moreover, the apparatus 1 originally comprises a plurality of conveyor elements 5, or of animation assemblies 10, arranged in parallel planes, each defining a closed line having at least one rectilinear segment arranged in such a way that the corresponding filters 4 (or the filters associated to each conveyor element 5) intercept the light beam moving along a straight line that is perpendicular thereto.

This advantageously enables to generate a multiplicity of animated effects, mutually combined.

Therefore, the present invention provides numerous advantages.

The apparatus 1 enables to combine projection of animations, mobility, versatility and combinations of optical effects, introducing also the possibility of projecting cyclic and/or sliding animations, e.g. a sentence entering from right to left and vice versa or a 360 degree landscape; or, it is possible, making filters defining raindrop shapes slide, to obtain a rain or downpour effect which can be oriented and, increasing the speed of actuation of the filters, the downpour can be transformed into a waterfall; alternatively to water, thanks to the fact that the filters are interchangeable (possibly also in automatic fashion), numberless patterns can be used, whose quantity has limits only in the imagination, e.g. fire, leaves, rocks, clouds, stars or any other image such as photos and captions; all without the aid of decoders or external equipment and with no need to rewind any film, thus enhancing the reliability and durability of the apparatus, maintaining weight and cost contained.

An additional advantage is given by the possibility of projecting the images in any direction, also interacting with other effects generated by additional means with which the apparatus is provided, e.g. means for varying the colour of the light beam: one can imagine wanting the aforesaid waterfall to change colour and to become a river of lava.

Combining the animation obtained with multiple transmission chains or belts present in the apparatus, one is able to triple or quadruple the quantity of effects available, obtaining shows of considerable effect.

The applications of this device in lighting engineering are numberless: in the theatre and in concerts to create spectacular animated backgrounds (today, systems are limited to projections of silhouettes, slides and/or giant video screens), in sporting events, television events and shows, in the architectural field to enhance and provide surreal atmospheres to various constructions, in discotheques and theme parks, in the installations of trade show and advertising stands and in any light show combined, possibly, to artificial fog and/or fountains and water spray effects.

1. An apparatus (1) for projecting images in continuous sequence, comprising:
a light source (11) positioned such as to direct a beam of light in a direction of projection;
a plurality of filters (4) with impressed shapes, able to project images corresponding to said shapes when they are traversed by the light beam;
a conveyor element (5) defining a closed line and movable in continuous cycle, the filters (4) being associated to the conveyor element in such a way as to intercept the light beam for generating an animated effect in the projection, said closed line defined by the conveyor element (5) having at least one rectilinear portion positioned perpendicularly to the light beam, in such a way that the filters (4) intercept the light beam perpendicularly thereto, in their movement along said rectilinear portion of the conveyor element,
characterised in that it comprises means for actuating the conveyor element (5) in a plane perpendicular to the projection axis between at least a first and a second operative position, such that the rectilinear portion of the conveyor element is inclined by a predetermined angle, in the passage from the first to the second position and vice versa.

2. An apparatus as claimed in claim 1; defining a substantially rectangular hole positioned downstream of the light source, in such a way that the hole is traversed by the light beam and defines the projection area and perimeter.

3. An apparatus as claimed in claim 1, wherein the conveyor element (5) is positioned in a plane that is substantially perpendicular to the direction of projection.

4. An apparatus as claimed in claim 1, wherein the conveyor element (5) comprises a chain (6) associated to a crown gear (7) and to at least one transmission (8), the crown gear being connected to a motorization to set in rotation the chain or the belt (6).

5. An apparatus as claimed in claim 4, comprising means for reversing the direction of rotation of the conveyor element (5).

6. An apparatus as claimed in claim 1, wherein the conveyor element (5) is movable between an operative position, in which at least one of the filters (4) intercepts the light beam, and a deactivated position, in which the filters (4) are in a position of non interference with the light beam.

7. An apparatus as claimed in claim 1, wherein the rectilinear segment of the conveyor element (5) can be inclined with continuity by an angle of at least 180 degrees.

8. An apparatus as claimed in claim 1, comprising a plurality of conveyor elements (5) arranged in parallel planes, each defining a closed line having at least one rectilinear portion arranged such that the filters (4) associated thereto intercept the light beam moving along a straight line perpendicular thereto.

9. An apparatus as claimed in claim 1, comprising means for varying the coloration of the light beam.

10. An apparatus as claimed in claim 1, comprising a section interacting with the light beam to generate prismatic effects on the projected images.

11. An apparatus as claimed in claim 1, wherein the filters (4) are constituted by glasses.
